(19) United States
(12) Patent Application Publication
(10) Pub. No.: US 2008/0320001 A1
(43) Pub. Date: Dec. 25, 2008

(54) Collaboration System and Method for Use of Same

(76) Inventor: Sreedhar Gaddam, Flower Mound, TX (US)

Correspondence Address: SCOTT T. GRIGGS, 901 MAIN STREET, SUITE 6300, DALLAS, TX, 75202, US

(21) Appl. No.: 12/144,585

(22) Filed: Jun. 23, 2008

Related U.S. Application Data
(60) Provisional application No. 60/945,432, filed on Jun. 21, 2007.

(51) Int. Cl. G06F 17/30

(52) U.S. Cl. 707/9; 707/E17.005

(57) ABSTRACT

A system for managing data and communications over a network for an institution having a defined organizational structure is disclosed. A collaboration space includes interconnected collaboration points having an accessible object, a history log, and digital rights management controls. Mappings extend from access profiles associated with individuals within the defined organizational structure to appropriate collaboration points that include the digital rights management controls permitting access to the corresponding accessible objects by the access profiles. The mappings enable different individuals to have different perspectives of the collaboration space as well as view the collaboration space from a third-party perspective providing details of the access of third-party to an individual's mapping or omniscient perspective providing details of the access of a particular collaboration point.

### PRIORITY STATEMENT & CROSS-REFERENCE TO RELATED APPLICATIONS

This application claims priority from co-pending U.S. Patent Application No. 60/945,432, entitled “Web-based Business Communication Portal for Efficient and Effective Communication Within and Across Organizations” and filed on Jun. 21, 2007, in the names of Sreedhar Gaddam and Arnold Kogan; which is hereby incorporated by reference for all purposes.

### TECHNICAL FIELD OF THE INVENTION

This invention relates, in general, to data management systems and, in particular, to a system and method for data and communication management over a network such as the Internet to enable a cooperative and collaborative experience in a professional or social networked environment, for example.

### BACKGROUND OF THE INVENTION

Traditional businesses and institutions, whether those in government, academia, healthcare services, financial services or the like, each have a structured organizational hierarchy of individuals that are constantly generating and storing ever increasing volumes of data in electronic formats. Such records are critical to operations and must be managed properly in order to derive their full value. In these traditional businesses and institutions, data as well as other forms of electronic communication must flow through multiple layers between the two parties communicating. This creates unnecessary lags and may lead to miscommunications resulting in loss of productivity and opportunities. There is therefore a need for a data and communication management system that facilitates direct relationships between individuals within traditional businesses and institutions and across these traditional entities. Further, a need exists for a data management system that monitors and tracks document usage in relation to the user's organizational structure.

### SUMMARY OF THE INVENTION

A system and method for managing data and communications over a network is disclosed. In one embodiment, system for managing data and communications over a network is employed for an institution having a defined organizational structure. A first database containing the organizational structure and organizational structure information includes information identifying first and second individuals on the organizational structure. Each of these individuals has a respective access profile that may be connected to one or more accounts. A collaboration space, which is contained in a second database, includes a plurality of interconnected collaboration points having an accessible object, a history log, and Digital Rights Management (DRM) controls. A first mapping extends from the first access profile to a first subset of the interconnected collaboration points. Similarly, a second mapping extends from the second access profile to a second subset of the interconnected collaboration points. Each mapping includes the DRM controls permitting access to the corresponding accessible objects to enable recordation in the history log of the access.

These mappings enable unique relationships in the collaboration space. By way of example, the mappings enable different individuals to have different perspectives of the collaboration space as well as view the collaboration space from a third-party perspective providing details of the access of a third-party to an individual's mapping or an omniscient perspective providing details of the access of a particular collaboration point.

In particular, the systems and methods presented herein break barriers found in traditional data and communication processes to streamline productivity by facilitating direct relationships between individuals within and across traditional organizational structures. Moreover, data management is achieved that tracks data usage in relation to the organizational structure. This permits traditional businesses and institutions to collaborate more dynamically, efficiently, and effectively.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is schematic diagram of a system for data and communication management over a network according to one embodiment;

FIG. 2 is a schematic diagram of the system of FIG. 1 being utilized to enable collaboration;

FIG. 3 is a schematic diagram of one embodiment of a defined organization showing an organization chart having a department level, a group level, and individual levels;

FIG. 4 is a schematic diagram of one embodiment of a portion of a collaboration space;

FIG. 5 is a schematic diagram of a collaboration point in one embodiment;

FIG. 6 is a schematic diagram of one embodiment of a permission structure used for the collaboration space;

FIG. 7 is a schematic diagram of two individuals collaborating in one embodiment;

FIG. 8 is a schematic diagram of one embodiment of interactions between individuals and the collaboration space;

FIG. 9 is a schematic diagram of one embodiment of further interactions between individuals and the collaboration space;

FIG. 10 is a flow chart of one embodiment of the object usage aspect;

FIG. 11 is a flow chart of one embodiment of a method for data and communication management over a network; and

FIG. 12 is a flow chart of another embodiment of a method for data and communication management over a network.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

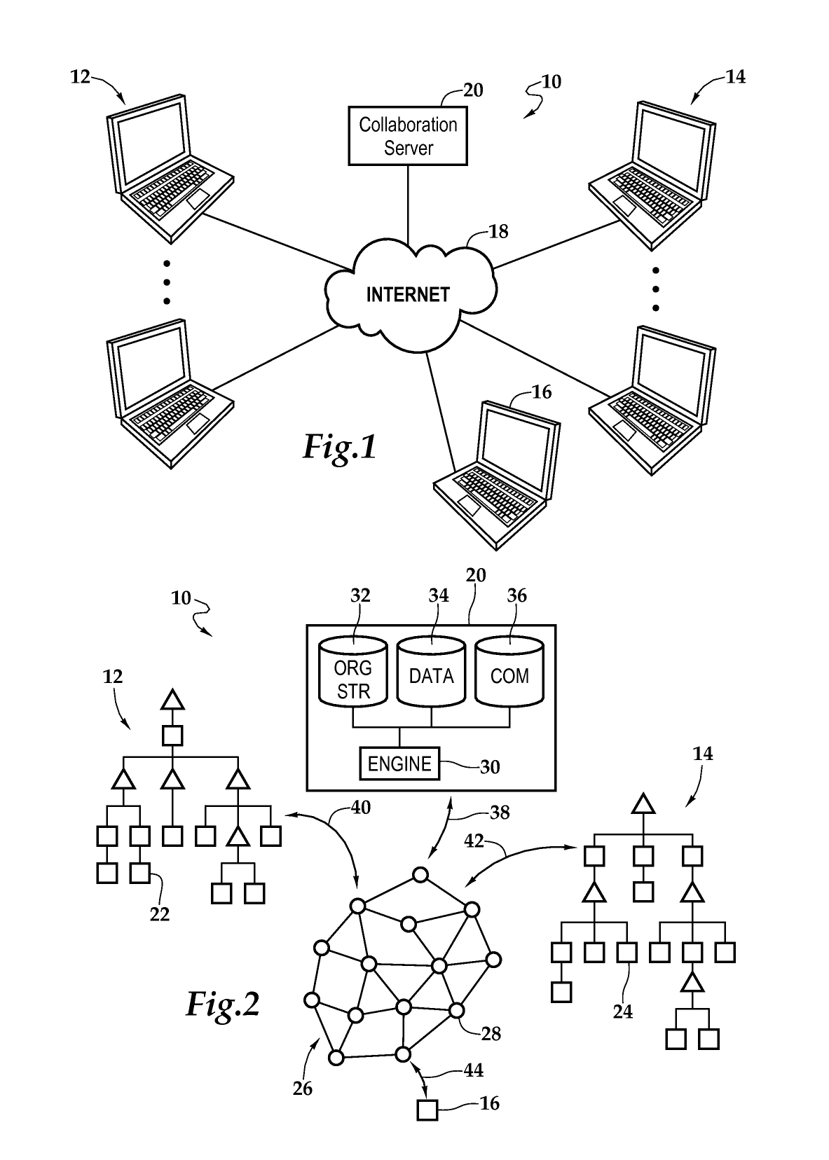

Referring initially to FIG. 1, therein is depicted a system for data and communication management that is schematically illustrated and generally designated 10. Institutions 12, 14, whether businesses, government, academia, healthcare services, financial services, an organization or the like, may utilize the system 10. The system 10, however, is not limited to institutions. Smaller unorganized groups and individuals, such as individual 16, may utilize the system 10 as well. The institutions 12, 14 and individual 16 are connected by a network, which is shown as Internet 18. A collaboration server 20 introduces an Internet-based portal that connects the institutions 12, 14 and individual 16 at an individual user-level. It should be appreciated that the institutions also include companies of all sizes, home based businesses, groups, sports clubs, for example.

FIG. 2 depicts the system 10 being utilized to enable collaboration. The institutions 12, 14 each have a defined organizational structure, respectively numbered 22, 24. A collaboration space 26 includes interconnected collaboration points 28. The collaboration server 20 includes an engine 30 having any combination of hardware, software, and firmware to enable the collaborations. A database 32 contains the organizational structures 22, 24 and organizational structure information including information identifying the individuals on the organizational structures 22, 24. A second database 34 contains the collaboration space 26. A third database 36 stores information about communications between individuals utilizing the collaboration space 26. In fact, the collaboration server 20 establishes the collaboration space as shown by line 38. It should be appreciated that although a particular architecture is shown for the collaboration engine 30, other architectures and platforms are included in the teachings presented herein. For example, although three databases are presented, it should be understood that the databases may be partially or completely integrated.

Mappings, as represented by numbers 40, 42, 44, extend from each of the individuals in the organizational structures 22, 24, as well as the individual 16, to respective subsets of the interconnected collaboration points 28. As will be discussed in further detail hereinbelow, for each individual the mappings 40, 42, 44 include the subset of interconnected collaboration points to which the individual has some level of access as determined by DRM controls associated with the collaboration point 28 and an access profile associated with the individual.

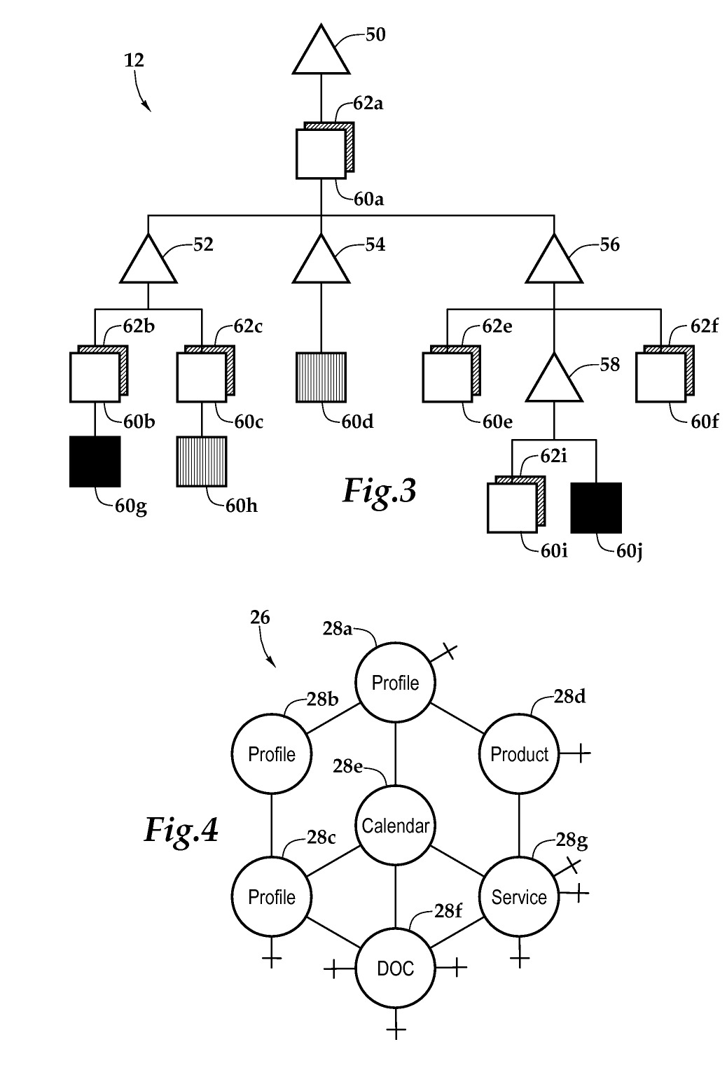

FIG. 3 is a schematic diagram of one embodiment of a defined organization 50 showing an organization chart by way of the organizational structure 22. The organizational chart, as is ordinarily the case, is a pyramid shaped hierarchical graphical arrangement of positions and titles, as well as interrelationships of such positions within the organization. In particular, department levels, group levels, and individual levels are illustrated. As shown, departments 52, 54, 56 are present as is group 58. In this presentation, the status of each individual with respect to the collaboration system 10 is presented. Each individual 60a through 60j, collectively individuals 60, may be a signed member, an unsigned member, signed nonmember, or a signed member with errors in the account information.

By way of example, individual 60a is a signed member having an access profile 62a that interfaces with DRM controls to permit access or deny access to a corresponding accessible objects. Each access profile 62 is unique and each individual 60 is assigned one access profile once membership into the collaboration space 26 is established. Individual 60j is an unsigned member, i.e., an individual recognized as part of the organization that has completed the enrollment process yet, as represented by the solid shading, individual 60d is a signed nonmember as represented by the vertical shading, and individual 60e is a signed member having errors in the account information as represented by the displayed “x”. In one implementation, an administrator having access to the organizational chart oversees the individual account maintenance duties. In another implementation, the account maintenance duties are distributed among the individual members, handled automatically by a computer, or some combination thereof is utilized. Further, it should be appreciated that the collaboration engine 30 can dynamically change the organizational structure 12 with respect to participating individuals as well as the status of each of the participating individuals.

FIG. 4 depicts a portion of the collaboration space 26 in further detail. As discussed, the collaboration space 26 includes interconnected collaboration points 28 and in particular collaboration points 28a through 28g. Each collaboration point 28 represents a space and an opportunity for collaboration and communication between individuals 60. By way of example and not by way of limitation, the following table, Table I, enumerates the types of accessible objects associated with the collaboration points:

TABLE I
Types of Accessible Objects

| Type | Definition |
|---|---|
| profile | outline of the characteristics of an |
| | individual that provide a degree of |
| | public disclosure such as name, job |
| | title, job description, resume, etc. |
| contact | information to enable communication |
| information | |
| product | goods being offered for sale by the |
| offering | individual |
| document | information in the form of a spreadsheet |
| | or word processing file, for example |
| data file | set of related records |
| service | services offered for sale by the |
| offering | individual |
| file case | virtual briefcase of information |
| conference | virtual location for a consultation or |
| | discussion |
| calendar | scheduling tool |
| meeting space | virtual location for informal |
| | interactions |
| groups/ | various hierarchical arrangements or |
| organizations/ | groupings of individuals—which may |
| corporations/ | include a common personal, business, or |
| companies/ | academic interest, for example |
| academic | |
| institutions/ | |
| departments/ | |
| businesses/ | |
| classes | |
| assignment | project for completion—possibly by a |
| | date certain |
| event | future occurrence at which individuals |
| | may participate |

A portion of the profiles define edge profiles which establish access to the interconnected collaboration points by the access profiles of individuals in an n:1 ratio, wherein n>1 and is a counting number such that n=1, 2, 3, . . . . In this manner, the edge profiles 28a, 28b, 28c may be considered the portals to user accounts. Accordingly, the system 10 provides multiple user accounts with a single user name and password as represented by the access profile.

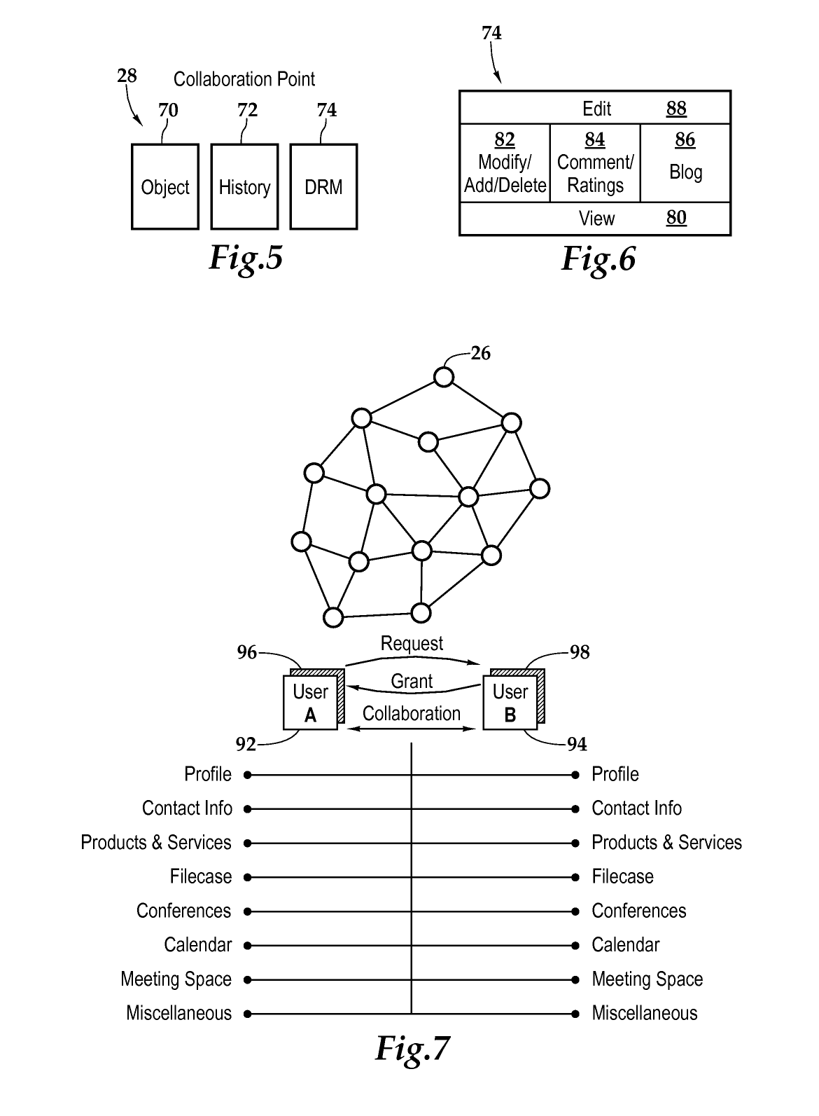

FIG. 5 depicts one embodiment of a collaboration point 28. An accessible object 70, history log 72, and DRM controls 74 are included. As previously mentioned, the accessible object 70 may include a profile, contact information, product offering, document, data file, service offering, file case, conference, calendar, or meeting space, for example. Further, an accessible object may include one or more other accessible objects. For example, an accessible object 70 may include contact information and a product offering. Additionally, the accessible objects 70 may include partially redacted versions of accessible objects 70. By way of example, an accessible object 70 may include a contact list and a redacted version of the contact list indicating only the company names of the individuals on the contact list. Only a user with edit privileges would be able to see the contact list while other individuals with less than edit privileges could interact with the redacted version. This application of redacted versions of accessible objects and having different levels of interaction applies to all of the accessible objects.

The history log maintains information including the date and time of the operation, the individual who performed the operation, the elements of the accessible object that were selected for the operation, any parameters explaining the details of the operation, comments entered by the individual performing the action, detailed source elements, if applicable, to enable tracking of all actions back to its origin. The DRM controls provide access control-based technology to appropriately limit the interaction between the accessible object and the individual.

FIG. 6 illustrates one embodiment of a modular permission structure used for the collaboration space as part of the DRM controls. This modular permission structure may be applied to any of the aforementioned accessible objects. In this hierarchical presentation, three layers of permissions are presented. At the base layer, the view privilege provides an individual the right to review the accessible object. At the next higher layer, a modify or an add/delete privilege, a comment/rating privilege, and a blog privilege are located. These privileges are concerned with adding or removing content, rating or otherwise critiquing the content in the accessible object, and participating in an online diary discussion about the accessible object, respectively. It should be appreciated that in some instances, an individual may have more than one of these privileges. Further, with any of these three privileges, the view privilege is provided. Full edit privileges at the highest layer provide superuser or administrative rights to control the accessible object. These rights include all of the add/delete, comment/ratings, and blog privileges as well as the view privileges. It should be further appreciated that the modular permission structure presented herein is not the only modular permission structure that may be employed with the present invention. Modular permission structures that vary from that presented here are also within the teachings of the present invention.

FIG. 7 illustrates one embodiment of two individuals collaborating in one embodiment. These individuals are labeled as users 92, 94 having respective access profiles 96, 98. These individuals 92, 94 may be members of the same or different groups. Further, these individuals 92, 94 may be part of larger organizations or independent. Regardless of their affiliations, the collaboration space 26 provides a vehicle for interacting with the various collaboration points defined by their respective accessible objects. Initially, the individuals 92, 94 must both have access through the appropriate DRM controls to collaborate. By way of example, the individual 94 owns or has edit privileges of the collaboration point 28. Through a request and grant access protocol, the individual 94 can modify the DRM controls associated with the collaboration point 28 to give the individual 92 the appropriate level of access to enable collaboration.

With respect to the accessible object and, in particle the profiles, individuals may interact by listing jobs or individual title(s) (e.g., engineering manager or student), company or school name, job function, job description, length of experience on the current job, company, contacts (emails, phone numbers), alternative contacts (superiors and/or subordinates), company/department/group name, company/department/group organization chart under a specific profile name. By way of further example, profiles may also include the following: resume, accomplishments, awards, previous jobs and/or companies worked for, years of experience in each job/company and basic designations and titles, home page address on the internet, external activities such as philanthropic, community, mentoring, leadership, awards, recognitions, publications and articles, patents. Individuals may also enter a description of their expertise or keywords that other individuals may use in search statements. Individuals may search for other's profiles based on any number of search criteria such as company name, job title, job function, or years of experience, for example.

The contact information lists all contacts known to the individual. An individual may partially redact the contact list to create a public contact list that is accessible by others and through the collaboration space. Individuals can invite other individuals to create new contacts by (i) searching based on either name and company name or email address and if the account exists, or (ii) entering an email address, first and last name, for example. In both cases, the individual may specify the relationship, e.g., direct supervisor, direct report, colleague, from a pull down menu. The collaboration engine then sends a request to the individual informing the individual of the request. Using a “push” technique, if the requested individual doesn't have an account, then the collaboration engine initiates the process of creating an account and access profile. In one implementation, only members of the institution are permitted to view the entire organization structure unless the institution agrees to release and make the entire organization structure open to public. In addition, a group or department within an institution may be made open to public.

Individuals may offer products and services in accordance with organization policies. This feature not only permits advertising materials to be displayed, but an individual may also present price quotes, a time line of when the products/services will be offered or purchased, and immediate sale/purchase for consideration, for example. Other individuals, whether buyers or sellers, can search for matching products or services or information of interest and make contacts through the collaboration space. In this way, the systems and methods presented herein function as both a marketplace and social network.

The filecase is a folder utilized to upload files, links, other information from the desktop, and for other sources. Individuals may also create folders with appropriate names and assign access levels for the entire folder. The filecase is similar to a desktop with significant improvements. Any file can be linked to other accessible objects such as events, meetings, or groups, for example. Moreover, individuals can create folders that more than one individual may access. Groups of individuals may be provided access to a single accessible object or a group of accessible objects. Further, as discussed, these accesses can include an accessible object containing and/or providing access to another accessible object.

Events are searchably listed. These events may include conferences, seminars, tradeshows, exhibitions, group meetings, or job/recruitment fairs, for example, include information about the event, which may have a physical or virtual location. Individuals may search for events and select from options relating to attending as an exhibitor, presenter, or audience member/visitor. Individuals may also send an invitation to other individuals with a brief description of the event.

In a case where an event was not listed by the individuals acting as organizers before the event is searched, then the first individual searching for the event has the option of entering and initially creating the collaboration point. Subsequent individuals can locate the event and once official organizers locate the event, the ownership or highest access privileges are transferred to the organizer. In this manner, the collaboration system sorts out the data and formats it to prevent duplication.

The calendar may be used to inform other individuals of events and contact opportunities. Similar to the contact list, an individual may create a redacted version of the calendar that is accessible by others. With respect to the meeting space, an individual may initiate and invite other individuals or users to the meeting. Meeting invitations may be sent by email and it will also show up on all the participants' meeting space. Individuals may accept, deny or tentatively accept the meeting request. Email links, history, and a collection of files to be discussed at the meeting are also included at the meeting space collaboration point. It should be appreciated that the teachings presented herein are not limited to the accessible objects discussed. By way of example, other accessible objects include folders, messages, groups, and organizations, for example.

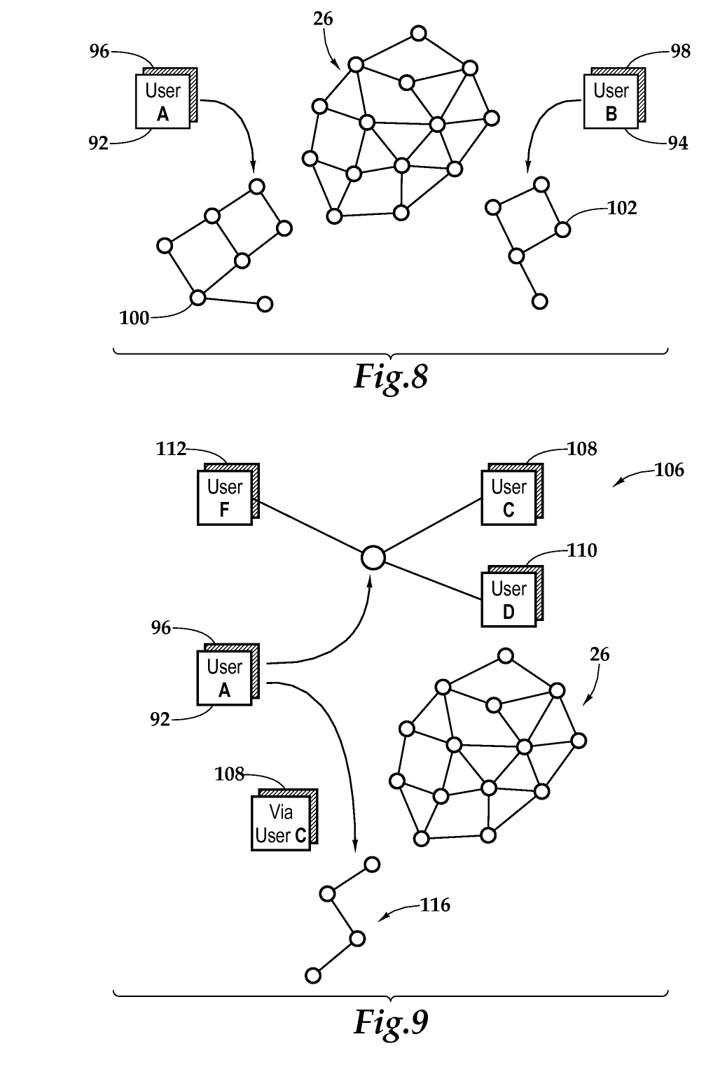

FIG. 8 depicts one embodiment of interactions between the individuals 92, 94 and the collaboration space 26. Each individual 92, 94 has a different perspective of the collaboration space. The respective perspectives of the collaboration space 26 are numbered 100, 102. Each perspective 100, 102 of the collaboration space 26 is formed by the aforementioned mappings to include only those collaboration points having DRM controls that give the individual a level of access. Further, each of the respective perspectives 100, 102 are subsets of the collaboration space that may include overlapping or common collaboration points.

FIG. 9 illustrates one embodiment of further interactions between individuals and the collaboration space. The individual 92 is interacting with the collaboration space 26 in two ways in the depicted drawing. With respect to perspective 106, the individual 28 is the owner or has edit privileges for the collaboration point 28. The individual 92 is chosen to view collaboration point 28 in terms of which individuals have access to the collaboration point and at what level of access. As shown, the individual 108 has blog privileges as does individual 112, while individual 110 has view privileges.

With respect to perspective 116, another third-party perspective is depicted wherein the individual 92 views the collaboration space 26 in terms of the user 208. This perspective 116 is formed by the intersection of the mapping to the individual 92 and the mapping to the individual 108. With this perspective, the individual 92 may view files of which the individual has edit privileges, for example, by way of the individual 108. With this tool then, the individual 92 may quickly and easily ascertain which accessible objects, and how much accessibility, the individual 108 maintains with respect to the accessible objects under the control of individual 92. Accordingly, a third-party perspective of the collaboration space is formed by an intersection of two mappings and an omniscient perspective of a collaboration point is formed by an intersection of an access profile and the digital rights management controls of the collaboration point.

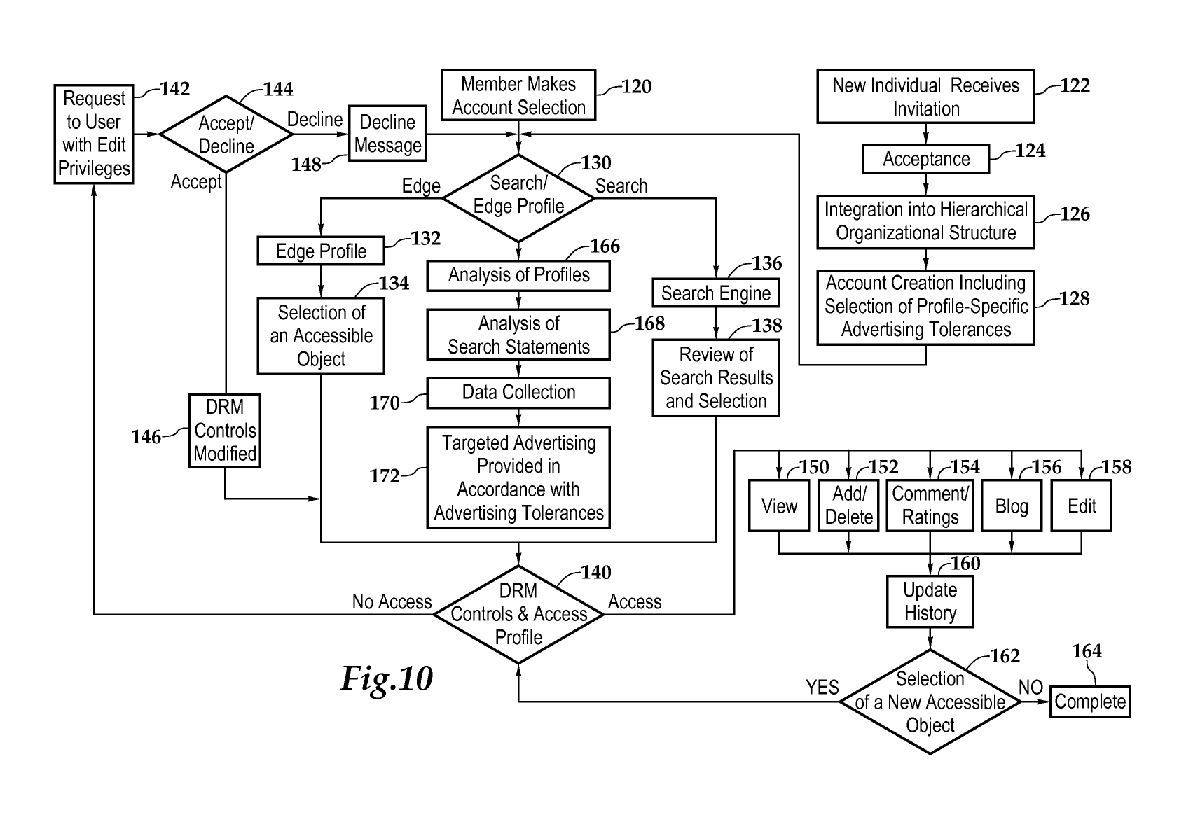

FIG. 10 illustrates one embodiment of a method for managing data and communications over a network. This flowchart depicts the object usage aspects of the present teachings. At block 120, a member makes an account selection. If the individual making the account selection is not a member, then at block 122 the new individual either receives an invitation to join or requests to join the collaboration space. The request from an individual who is not a member on the organizational chart is then routed to an administrator, a member individual or the collaboration engine so that the individual may be properly enrolled in the collaboration system. At block 124, this enrolling process begins with the individual accepting the invitation. At block 126, the individual is integrated into one or more hierarchical organizational structures.

As part of the account creation process, accounts include a selection called “groups” where open groups looking for membership are listed. By way of example, these groups may include business/company affiliations, academic affiliations, non-profit organizations, and miscellaneous and social groups. An individual also has the power to create new groups or create groups which are sub-groups of other groups or organizational structures. As previously discussed, with the single account, an individual can have multiple profiles. For example, an individual may select to have a business profile, an academic profile, and a social or private profile. The individual may later select any of these accounts to begin the collaboration experience from.

At block 128, the account creation process continues by including the individual's selection of profile-specific advertising tolerances. As will be described in further detail hereinbelow, the collaboration systems and methods presented herein include the ability to provide individuals targeted advertising based on criteria aggregated from the individual's profiles and collaboration history.

At decision block 130, whether the individual is already a member or just joined, the individual begins interfacing with the collaboration system by searching for a specific file or groups or visiting an edge profile page. Additionally, the individual may search, through a series of queries, any of the history files associated with the accessible objects; assuming the individual has the proper DRM control clearance. At block 132, the individual visits an edge profile page, such as corporate page, academic page, or personal page. At this page, at block 134, the individual selects an accessible object where the process will advance to decision block 140.

As an alternative to beginning the process at an edge profile page, the individual may utilize a search engine at block 136 to search for an individual, specific file, or group, for example. The concept of searching and selecting a specific group (or creating one and informing the actual head and others that want to be part of the group) is similar to the handling of events. Files may be associated to the group and the creator or owner of the group can assign access level through the DRM controls. The assigned access level may vary and apply to everyone, a specific organization, a specific group, or by applied on a case-by-case basis. Further, different individuals or groups of individuals may be assigned different levels of access. Groups may be based on any set of criteria similar to searching for individuals. In addition, the entire group/organization structure (without the members in the group) can be viewed by anyone depending on the groups'/group structure's view properties and can request to participate.

By way of example, a professor can create a class as a group, and invite the students to become part of the group or students can search for the class and request professor to add them to the class. If the group (or class, in this case) doesn't exist, a student can either send a request to the professor to create the class or create one by himself/herself and assign professor as the owner. The professor can place class materials, grades etc. which only students belonging to that class can access. In addition, only students within that class (or group) can view other students (or members) within that class because the professor doesn't allow others to view the files or students list in the class and students can communicate with other students. Others can only view the profile (e.g., who is the head of the group (professor in this case)), summary of the class such as what is taught in the class, syllabus summary and/or details, when, where and what days the class meets, or anything the professor chooses others (non-group members) can view. Moreover, the professor and students can enter comments/notes about the class that students can view, students can rate the class and/or professor. Students can place their assignments, thesis, or dissertations, for example and professor can view them. Some or all of this info can be viewed by non-group members and this can help them decide if they can enroll for the class the following semester/quarter. The class can be part of one or more departments (which are one higher-level groups) which in turn are part of the entire school/university which is yet another higher-level groups. This feature can be used by anyone to search for specific classes, for example, before enrolling in that class or school.

By way of another example, a company or business organization structure is created using a combination of information from two different sources based on: (a) the company-wide (or internal) contacts added and the relation specified, and (b) the properties appropriate to the Group discussed above, for example. The latter may be used to correct and complete the individual group structures. In general, the head of a department is the creator/owner of a group although anyone within that department can create and assign ownership to the actual head of the group. The owner, in general, has the responsibility of the group's integrity and accuracy. Within this framework, the organizational structure may be searched and then viewed, verified and changed/corrected, or others can view it and a notification can be sent to the head of the department/group within the organization to make corrections. Unlike other groups discussed earlier, by default, an entire company's organization structure including all the employees within it (i.e., members of individuals within groups/departments) can be viewed by other employees within that company. Individuals external to the company cannot view the organization structure unless the company agrees to open the entire company organization or specific groups within the company for general users' view.

At block 138, following the searching, the individual selects a search result. This result may relate to an individual, file, group, or other type of accessible object, for example. At block 140, the collaboration engine receives and verifies a request to access a specific collaboration point. At block 142, if the individual does not have the appropriate level of access, then a request is sent to the individual having ownership or edit privileges over the file. At block 144, this individual either favorably accepts the request by granting a level of DRM controls at block 148 or the request is declined at block 148.

At blocks 150 through 158, the individual is then given the appropriate level of access in accordance with the access profile and the DRM controls. Following the access and interaction with the collaboration point, the history is updated for the collaboration point at block 160. The systems and methods presented herein are directed to the automatic creation of a history charts. Data for the document usage or other accessible object usage is collected automatically when the DRM controls verify the access profile of the individual requesting the document. Mapping the document access and treatment to the institution's organizational chart enables and empowers the repository and institution management to make very informed and precise decisions on how to label or treat particular objects and documents. At block 162, a new accessible object is selected and the process returns to block 140, or, alternatively, if the individual has completed interacting with the collaboration space, the experience is complete at block 164.

Returning to block 130, in addition to the searching and initial edge profile positioning of the individual, the collaboration systems and methods presented herein analyze the profiles of the individual at block 166 and at block 168 analyze the search statements and other collaboration behavior. At block 170, based on this data collected a profile is aggregated of the individual by comparing the education, interests, and other details of the individual to a set of heuristics and advertising profiles. At block 172, targeted advertising is provided to the individual. As previously mentioned, the individual has selected advertising tolerances for each of the individual's profiles. By way of example, an individual may have three profiles as shown in the following table, Table II, and the individual may wish to select a different advertising frequency for each profile.

TABLE II
Exemplary Use of Advertising Scaler

| Profile | Advertising Scaler Setting |
|---|---|
| Personal | Low Advertising Permitted |
| Academic | Medium Advertising Permitted |
| Professional | No Advertising Permitted |

As shown, the individual has multiple profiles and for each profile, the individual has selected a level of acceptable advertising by use of an advertising scaler. For the individual's personal profile, the individual wants to receive a low level of advertising. For the academic profile, the individual wants to receive a medium level of advertising and for the professional profile, no advertising. It should be understood that although the advertising scaler is presented herein as having only three levels of advertising to select from, the advertising scaler may be more granulated with many different discrete levels or provide selection from a spectrum of possibilities. This advertising system collects data from multiple profiles to form a composite advertising image of the individual while providing an individual-selected level of advertising targeted to the profile.

Throughout the operations of the systems and methods for collaborating presented herein, data integrity is maintained by preventing duplication and maintaining the uniqueness of an object. By way of example, if two individuals create the same object, then ownership is resolved by the system in favor of the individual that should own the object. Such issues may involve a transfer of ownership. For example, an individual may be interested in a conference and not find the conference within the collaboration space. The individual may then create the conference and own the conference until the conference organizer wants to create the event at which time ownership is transferred.

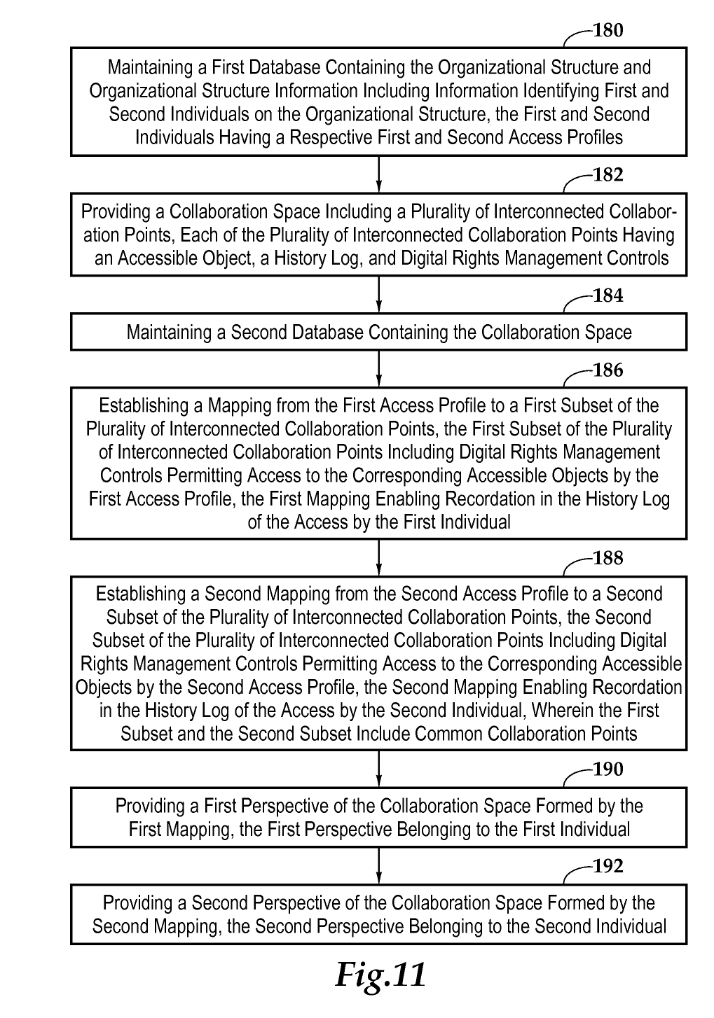

FIG. 11 is a flow chart of one embodiment of a method for data and communication management over a network. At block 180, a first database is maintained containing the organizational structure and organizational structure information including information identifying first and second individuals on the organizational structure. As previously mentioned, the first and second individuals have respective first and second access profiles. A collaboration space is provided at block 182 that includes the interconnected collaboration points. At block 184, a second database is maintained that contains the collaboration space.

At block 186, a mapping is established from the first access profile to a first subset of the interconnected collaboration points. The first subset of the interconnected collaboration points includes the DRM controls permitting access to the corresponding accessible objects by the first access profile. This first mapping enables recordation in the history log of the access by the first individual.

Similarly, at block 188, a second mapping is established from the second access profile to a second subset of the plurality of interconnected collaboration points. The second subset of interconnected collaboration points includes the DRM controls permitting access to the corresponding accessible objects by the second access profile. The second mapping enables recordation in the history log of the access by the second individual. The first subset and the second subset include common collaboration points.

At block 190, a first perspective of the collaboration space is formed by the first mapping for the first individual. Similarly, at block 192, a second perspective is provided of the collaboration space formed by the second mapping, the second perspective belonging to the second individual.

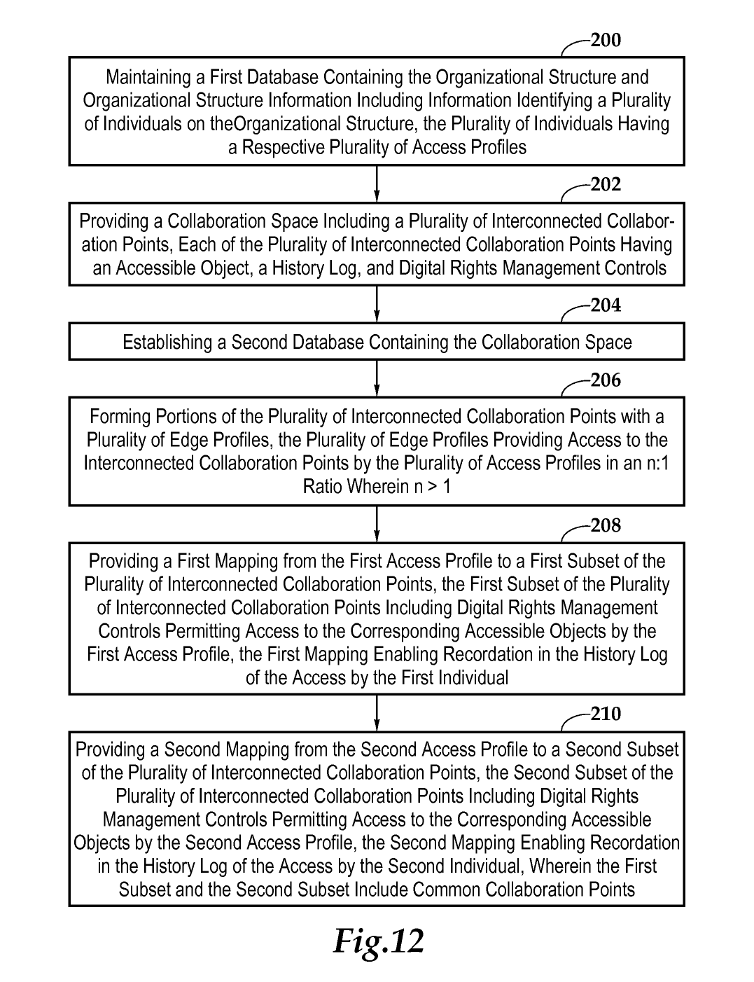

FIG. 12 is a flow chart of another embodiment of a method for data and communication management over a network. At block 200, similar to the discussion in FIG. 11, a first database is maintained for the first database containing the organizational structure and organizational structure information. At block 202, the collaboration space is provided and at block 204, a second database containing the collaboration space is established. At block 206, edge profiles form portions of the interconnected collaboration points. The plurality of edge profiles provide access to the interconnected collaboration points by the access profiles in an n:1 ratio, wherein n>1. In this manner, the edge profiles act as account profiles for the individual and an individual with a single user name and password as represented by the access profile has use of multiple account profiles. At blocks 208 and 210, mappings are provided from respective access profiles to subsets of the interconnected collaboration points. These mapping enabling recordation in the history logs of the access by the individuals. It should be understood that although only two mappings are presented, the number of mappings will depend on the number of individuals and the number of collaboration points. Any number of mappings may be supported by the teachings presented herein.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A system for managing data and communications over a network for an institution having a defined organizational structure, the system comprising:
a first database containing the organizational structure and organizational structure information including information identifying a plurality of individuals on the organizational structure, the plurality of individuals having a respective plurality of access profiles;
a collaboration space including a plurality of interconnected collaboration points, each of the plurality of interconnected collaboration points having an accessible object, a history log, and digital rights management controls;
a second database containing the collaboration space;
a plurality of edge profiles forming portions of the plurality of interconnected collaboration points, the plurality of edge profiles providing access to the interconnected collaboration points by the plurality of access profiles in an n:1 ratio, wherein n>1;
a first mapping from the first access profile to a first subset of the plurality of interconnected collaboration points, the first subset of the plurality of interconnected collaboration points including the digital rights management controls permitting access to the corresponding accessible objects by the first access profile, the first mapping enabling recordation in the history log of the access by the first individual; and
a second mapping from the second access profile to a second subset of the plurality of interconnected collaboration points, the second subset of the plurality of interconnected collaboration points including the digital rights management controls permitting access to the corresponding accessible objects by the second access profile, the second mapping enabling recordation in the history log of the access by the second individual, wherein the first subset and the second subset include common collaboration points.

2. The system as recited in claim 1, wherein the first and second databases are at least partially integrated.

3. The system as recited in claim 1, wherein the accessible object comprises an object selected from the group consisting of a profile, contact information, product offering, service offering, a file case, conferences, calendar, and meeting spaces.

4. The system as recited in claim 1, wherein the organizational structure and organizational structure information are dynamically updated.

5. The system as recited in claim 1, wherein information in each of the edge profiles associated with an individual forms an advertising profile for the individual.

6. The system as recited in claim 1, wherein each of the collaboration points are different.

7. A method for managing data and communications over a network for an institution having a defined organizational structure, the method comprising:
maintaining a first database containing the organizational structure and organizational structure information including information identifying a plurality of individuals on the organizational structure, the plurality of individuals having a respective plurality of access profiles;
providing a collaboration space including a plurality of interconnected collaboration points, each of the plurality of interconnected collaboration points having an accessible object, a history log, and digital rights management controls;
establishing a second database containing the collaboration space;
forming portions of the plurality of interconnected collaboration points with a plurality of edge profiles, the plurality of edge profiles providing access to the interconnected collaboration points by the plurality of access profiles in an n:1 ratio, wherein n>1;
providing a first mapping from the first access profile to a first subset of the plurality of interconnected collaboration points, the first subset of the plurality of interconnected collaboration points including the digital rights management controls permitting access to the corresponding accessible objects by the first access profile, the first mapping enabling recordation in the history log of the access by the first individual; and
providing a second mapping from the second access profile to a second subset of the plurality of interconnected collaboration points, the second subset of the plurality of interconnected collaboration points including the digital rights management controls permitting access to the corresponding accessible objects by the second access profile, the second mapping enabling recordation in the history log of the access by the second individual, wherein the first subset and the second subset include common collaboration points.

8. The method as recited in claim 7, further comprising dynamically updating the organizational structure and organizational structure information.

9. The method as recited in claim 7, further comprising developing an advertising profile from information in each of the edge profiles associated with an individual forms an advertising profile for the individual.

10. A system for managing data and communications over a network for an institution having a defined organizational structure, the system comprising:
means for storing a first database containing the organizational structure and organizational structure information including information identifying a plurality of individuals on the organizational structure, the plurality of individuals having a respective plurality of access profiles;
means for providing a collaboration space including a plurality of interconnected collaboration points, each of the plurality of interconnected collaboration points having an accessible object, a history log, and digital rights management controls;
means for storing a second database containing the collaboration space;
forming portions of the plurality of interconnected points with a plurality of edge profiles, the plurality of edge profiles providing access to the interconnected collaboration points by the plurality of access profiles in an n:1 ratio, wherein n>1;
means for establishing a first mapping from the first access profile to a first subset of the plurality of interconnected collaboration points, the first subset of the plurality of interconnected collaboration points including the digital rights management controls permitting access to the corresponding accessible objects by the first access profile, the first mapping enabling recordation in the history log of the access by the first individual; and
means for establishing a second mapping from the second access profile to a second subset of the plurality of interconnected collaboration points, the second subset of the plurality of interconnected collaboration points including the digital rights management controls permitting access to the corresponding accessible objects by the second access profile, the second mapping enabling recordation in the history log of the access by the second individual, wherein the first subset and the second subset include common collaboration points.

11. The system as recited in claim 10, further comprising means for dynamically updating the organizational structure and organizational structure information.

12. The system as recited in claim 10, further comprising means for developing an advertising profile from information in each of the edge profiles associated with an individual forms an advertising profile for the individual.
